(19) United States
(12) Patent Application Publication
(10) Pub. No.: US 2014/0130177 A1
(43) Pub. Date: May 8, 2014

(54) SYSTEM AND METHOD FOR CREATING A CERTIFIED ELECTRONIC RECORD

(71) Applicant: 9195-3984 QUEBEC INC., St-Hyacinthe (CA)

(72) Inventors: Pierre GRÉGOIRE, Beloeil (CA); Jacques LAFRANCE, St-Hyacinthe (CA)

(21) Appl. No.: 13/914,171

(22) Filed: Jun. 10, 2013

Related U.S. Application Data
(60) Provisional application No. 61/657,391, filed on Jun. 8, 2012.

(51) Int. Cl. G06F 21/45

(52) U.S. Cl. CPC G06F 21/45
USPC 726/26

(57) ABSTRACT

A system and method for creating a certified electronic record has data content forming record entries being associated together to from an uncertified electronic record. A user-made input for creating a certification mark is received. A visually identifiable certification mark is then generated from the input. A certified electronic record is created from the record entries of the uncertified electronic record and the visually identifiable certification mark.

### CROSS REFERENCE TO RELATED APPLICATIONS

This Application claims priority on U.S. Provisional Application No. 61/657,391, filed on Jun. 8, 2012, which is herein incorporated by reference.

### FIELD

The present description relates to a system and method for creating electronic records.

### INTRODUCTION

In many fields, use of electronic records is replacing the use of paper-based records. Electronic records are advantageous in being easy to sort and search, which greatly facilitates retrieval of relevant records.

### SUMMARY

The embodiments described herein provide in one aspect a method for creating a certified electronic record comprising: receiving an uncertified electronic record, the record comprising one or more entries; receiving at a capture device an input for creating a certification mark; generating from the input a visually identifiable certification mark; and creating the certified electronic record, the certified electronic record comprising the one or more entries and the visually identifiable certification mark.

The embodiments described herein provide in another aspect a system for creating a certified electronic record comprising: a memory for storing a plurality of instructions; a processor coupled to the memory, the processor configured for:
receiving an uncertified electronic record, the record comprising one or more entries;
receiving an input for creating a certification mark;
generating from the input a visually identifiable certification mark; and
creating the certified electronic record, the certified electronic record comprising the one or more entries and the visually identifiable certification mark.

### DRAWINGS

Reference will now be made to the accompanying drawings, showing by way of illustration various exemplary embodiments, in which:

FIG. 1 is a schematic diagram of a system for creating a certified electronic record;

FIG. 2 is a schematic diagram of a method for creating record entries of an uncertified electronic record;

FIG. 3 is a schematic diagram of a method for creating an uncertified electronic record;

FIGS. 4 and 4a are schematic diagrams of a user interface for creating an electronic record; and

FIG. 5 is a schematic diagram of a method for creating a certified electronic record.

### DESCRIPTION OF VARIOUS EMBODIMENTS

The present description relates to a system and method for creating electronic records, and more particularly to a system and method for creating certified electronic records having a visually identifiable certification mark.

While paper-based records do not present many of the advantages of electronic records, they have one advantage over many current electronic records systems in that paper-based records allows for easier retracing of who have viewed and approved certain records with a lower risk of tampering. It will be appreciated that being able to trace who created, verified and approved or certified a record is important in many fields. This may be the case where responsibility or liability may be attached to the content of a record and to who approved that content. For example in professional fields such as medicine or dentistry, a doctor or dentist often sign the paper-based records to approve them and may be held liable or responsible for any mistakes that appear in the record.

For example, where a paper-based record is handwritten, identification of the handwriting provides a reliable indication of the person who originally created the paper-based record. Even where the content of a paper-based record is typed, approval or certification of the content is provided by a person apposing their signature on the record. Examination of the signature allows ready and reliable identification of the person who certified the content. While forging of handwriting and signature remains a possibility, it has generally been accepted that handwriting and signatures provide a reliable identification associated to the person who hand-wrote the content and/or who signed the record.

By contrast, current electronic records lack the same type of reliable means for tracing who created and certified the content of a record. Typically, changes to an electronic record are attributed to the user account currently logged onto a system for accessing the electronic records. However, tracking the user account does not always indicate the individual attributed to the account is the same individual actually accessing the system through the user account. For example, passwords used to log in into a user account can be easily shared or stolen. Once such a password is shared or stolen, it is no longer possible to reliably ensure that any changes or certification of the content of an electronic record was actually made by the individual attributed to the account.

Therefore it is an object of the current description to provide an electronic record creation system and method that imitates to a certain extent the traceability offered by paper-based records. In particular, it is an object of the current description to allow a reliable way of tracing who made changes or certified the content of an electronic record.

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

The embodiments of the systems and methods described herein may be implemented in hardware or software, or a combination of both. However, preferably, these embodiments are implemented in computer programs executing on programmable computers, each comprising at least one processor, a data storage system (including volatile and non-volatile memory and/or storage elements), at least one input device, and at least one output device. For example and without limitation, the programmable computers may be a mainframe computer, server, personal computer, laptop, personal data assistant, cellular telephone, smartphone, or tablet device. Program code is applied to input data to perform the functions described herein and generate output information. The output information is applied to one or more output devices in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer for configuring and operating the computer when the storage media or device is read by the computer to perform the procedures described herein. The system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer-usable instructions for one or more processors. The medium may be provided in various forms including one or more diskettes, compact disks, tapes, chips, wireline transmissions, satellite transmissions, internet transmission or downloadings, magnetic and electronic storage media, digital and analog signals, and the like. The computer-usable instructions may also be in various forms including compiled and non-compiled code.

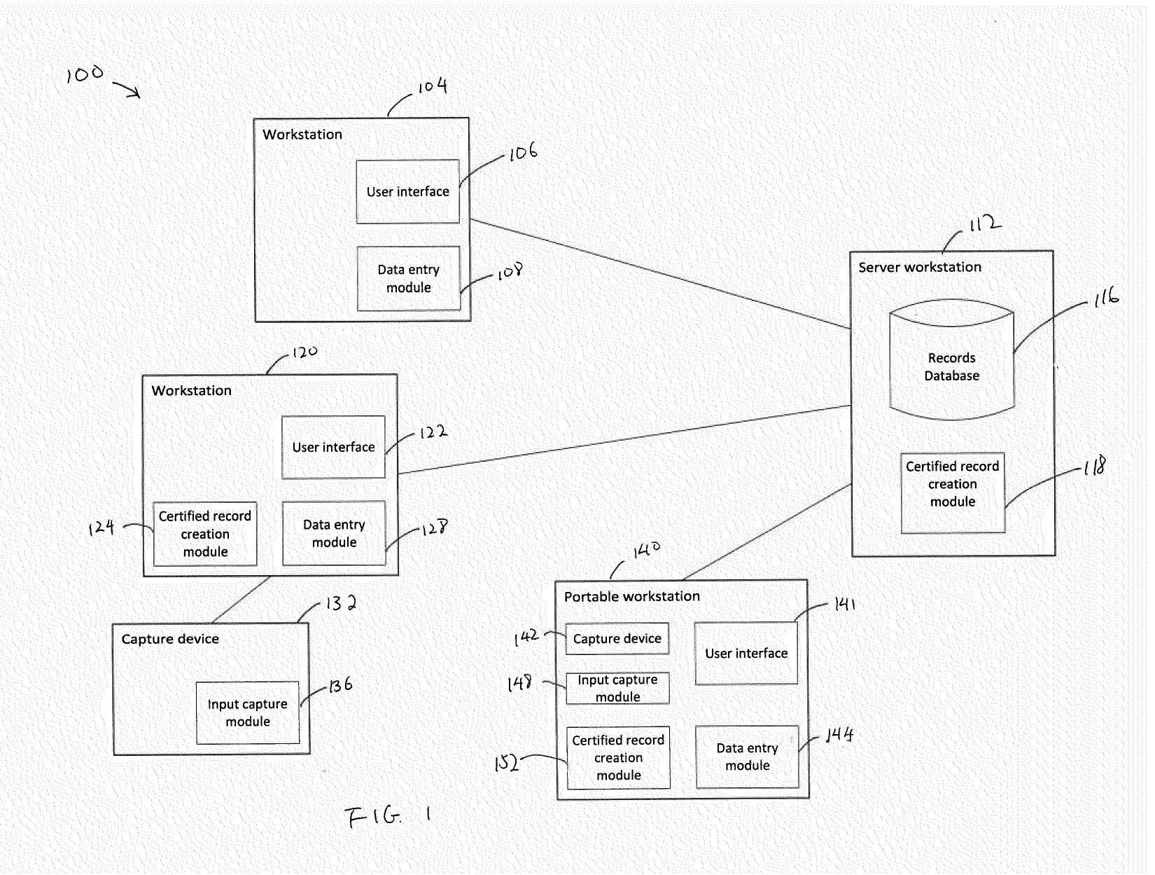

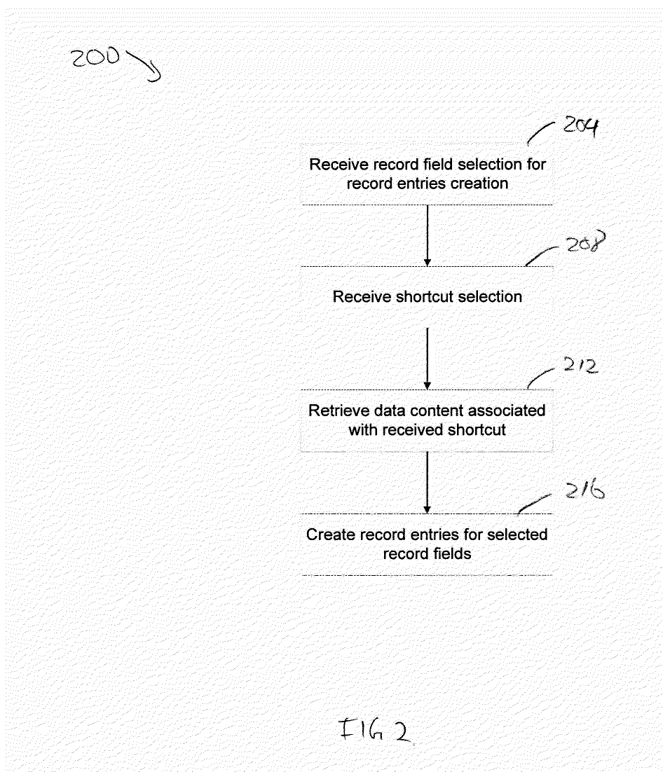

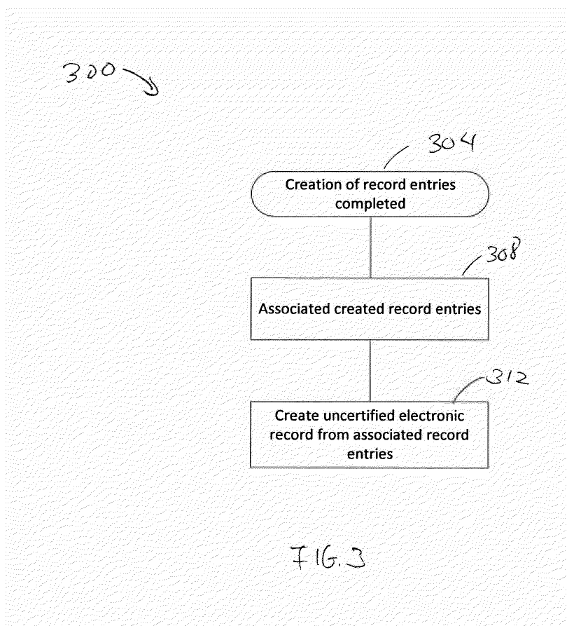

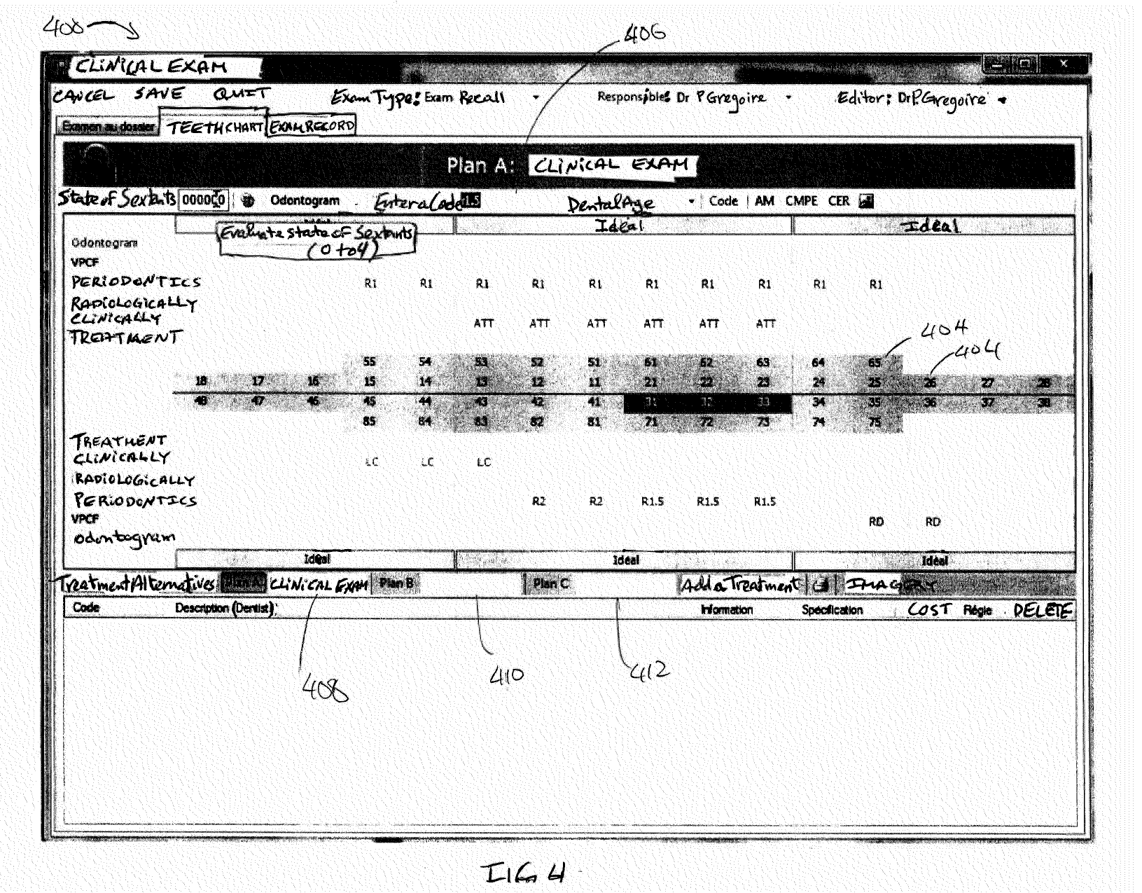

Referring now to FIG. 1, therein illustrated is a schematic diagram of a system 100 for creating a certified electronic record according to various exemplary embodiments. A first workstation 104 may be used to create uncertified electronic records. The first workstation 104 may comprise a user interface 106 having a display and suitable input device. The input device may be one or more of a keyboard, mouse, stylus, dictation device or touchscreen. The first workstation 104 comprises a data entry module 108, which receives user input and commands and generates an uncertified electronic record from the received input and commands.

The first workstation 104 may be connected to a server 112, which may be a typical network server. The server 112 comprises a records database 116 which stores one or more uncertified electronic records that may be accessed by workstations connected to the server 112. The records database may also store one or more certified electronic records, which may also be accessed by workstations connected to the storage device. The server 112 may also have a certified record creation module 118.

For example, the system 100 may further comprise a second workstation 120. The second workstation 120 may comprise a user interface 122, which has a display and suitable input device. The second workstation 120 further comprises a certified record creation module 124 and a data entry module 128. A first capture device 132 having an input capture module 136 may further be connected to the second workstation 120.

For example, the system 100 may further comprise a portable workstation 140. The portable workstation may comprise a user interface 141, which has a display and a suitable input device. The portable workstation further comprises an integrated capture device 142 within the portable workstation 140. The portable workstation 140 may further have a data entry module 144, input capture module 148 and certified record creation module 152.

An uncertified electronic record can be created or edited at any workstation, such as first workstation 104, second workstation 120, or portable workstation 140, having a data entry module, such as data entry modules 108, 128, or 144. An uncertified electronic record may be a set of one or more electronically stored data content that are associated together. Electronically stored data content may include text, images, videos, or sound recordings. The electronically stored data content form record entries for the uncertified electronic record.

Certain record entries may be created using the suitable input device of a workstation. For example, a user may create electronically stored data content to form record entries by using a keyboard, stylus, or dictation device to input text content or image content. For example, in many professional fields, such as medicine or dentistry, it may be typical for an assistant or support team to create the electronically stored data content from notes originally made by a professional, such as handwritten notes or dictated notes. Since the professional has not yet verified the electronically stored data content forming the record entries, the record entries are part of an uncertified electronic record.

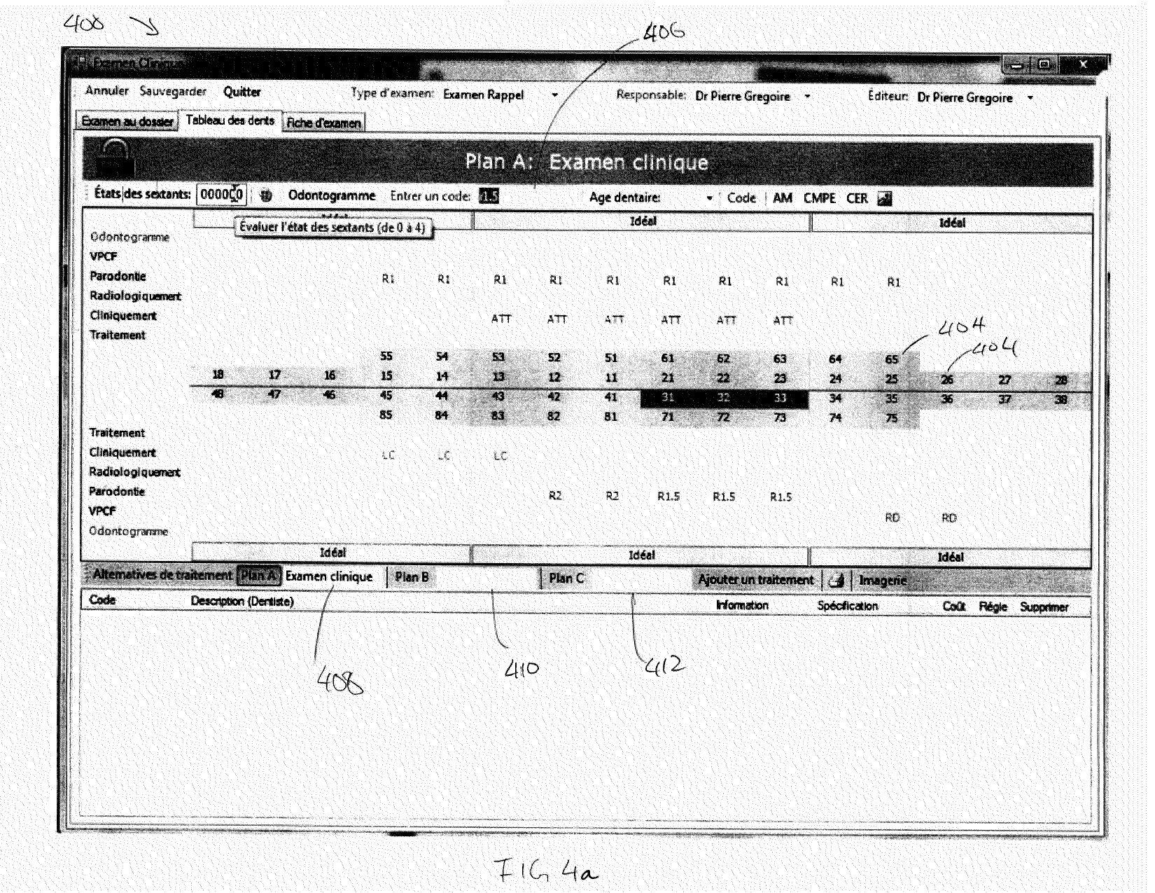

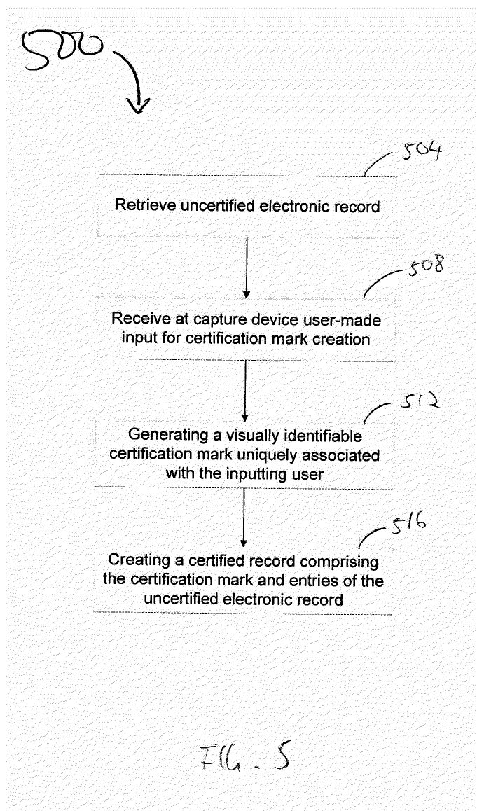

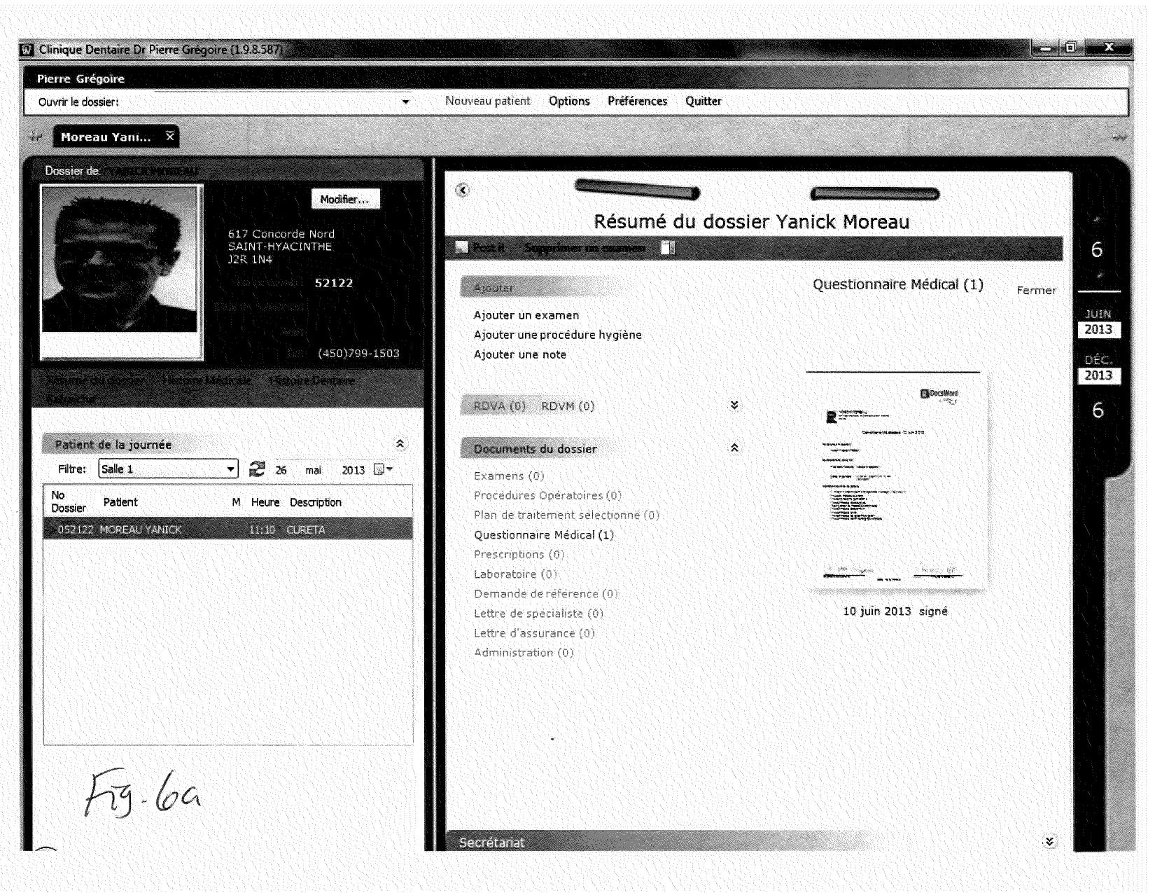

Referring to FIG. 2, therein illustrated is a schematic diagram of a method 200 for creating an uncertified electronic record. For example, steps of method 200 may be carried. out using any suitable data entry module of a workstation, such as data entry modules 108, 128, and 144. At step 204, a user selects one or more record fields for creating one or, more record entries. Selection of record fields may be made on a suitable user interface, such as interfaces 106, 122 or 141. The selection of the record field made on the user interface is then received at the data entry module of the same workstation. Record fields refer to various types of subjects that are to be included in the created uncertified electronic record. For example, in the field of medicine or dentistry, typical record fields may include “procedure completed”, “observations”, and “conclusions”.

Furthermore, in dentistry, specific record fields may include a record field for each tooth of the palette. At step 204, a user may simultaneously select more than one record field for record entry creation. This may be advantageous if the same record entry is to be made for each of the simultaneously selected record fields. For example, a record for a dental exam may have the same observations entries to be made for a plurality of teeth of the palette.

At step 208, a shortcut selection may be received for creating a record entry for each of the selected record fields. For example, where the record entry is to be textual data content, for example a text string, a user may type out the entire text string using the input device. However, to save time, the user may select on the user interface a shortcut that is associated to the data content. The user may make a selection of the desired shortcut on the user interface, for example from a drop-down menu, in order to retrieve the data content associated with the selected shortcut. Alternatively, the user may enter a textual code, which may consist of a few letters, that corresponds to a shortcut associated with data content for creating a record entry. For example, associations between shortcuts and data content may be preconfigured. For example shortcut keywords selections are received at a suitable data entry module, such as data entry module 106, 122 or 141.

At step 212, the data content associated with the selected shortcut is retrieved and used to create a record entry for each of the record fields selected at step 204. For example, where the selected record fields are teeth 31 and 32 and the selected shortcut corresponds to a textual data content having the string “exhibits plaque buildup”, the created record entry for each of the teeth may be “31 exhibits plaque buildup” and “32 exhibits plaque buildup”.

At step 216, the record entries for the selected record fields are created. For example, the created record entries may be stored within an uncertified electronic record in the records database 116.

Steps 204 to 216 of method 200 may be repeated for a plurality of selected record fields to create record entries for each of the selected fields.

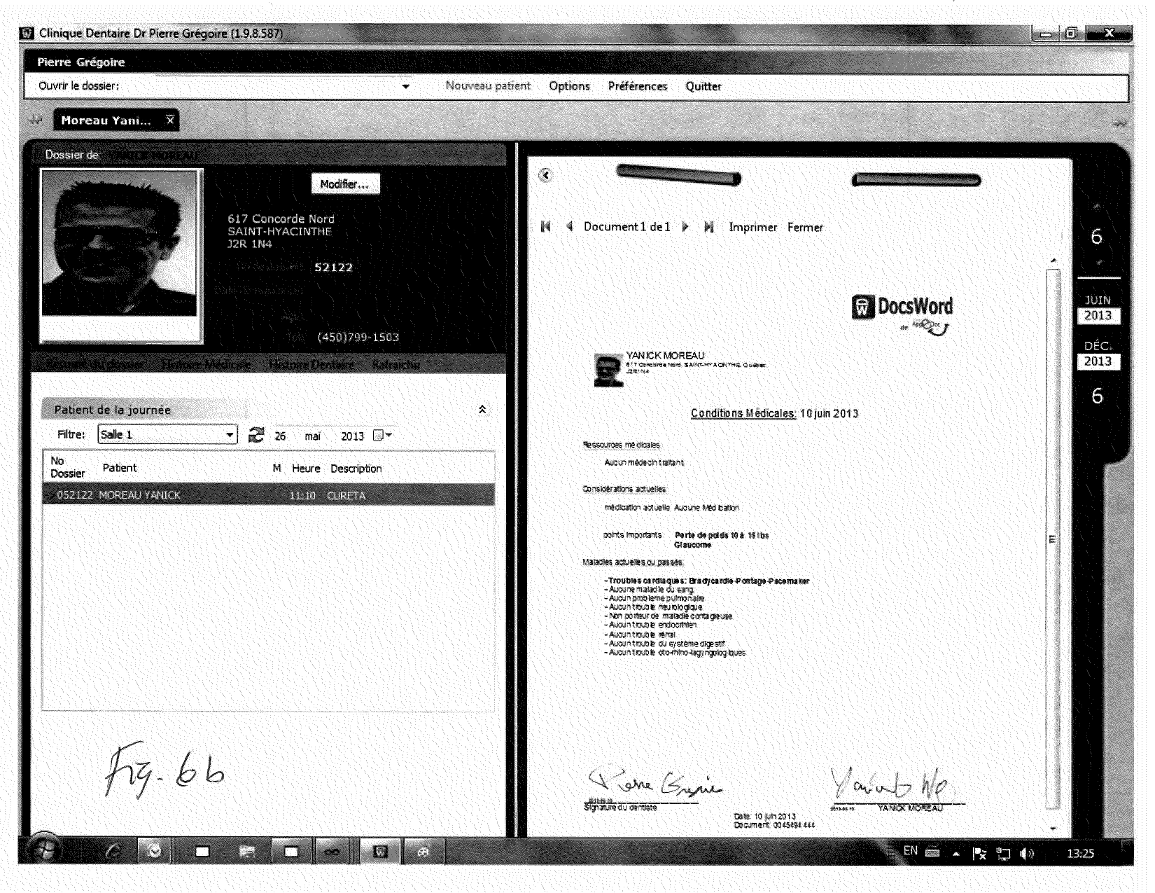

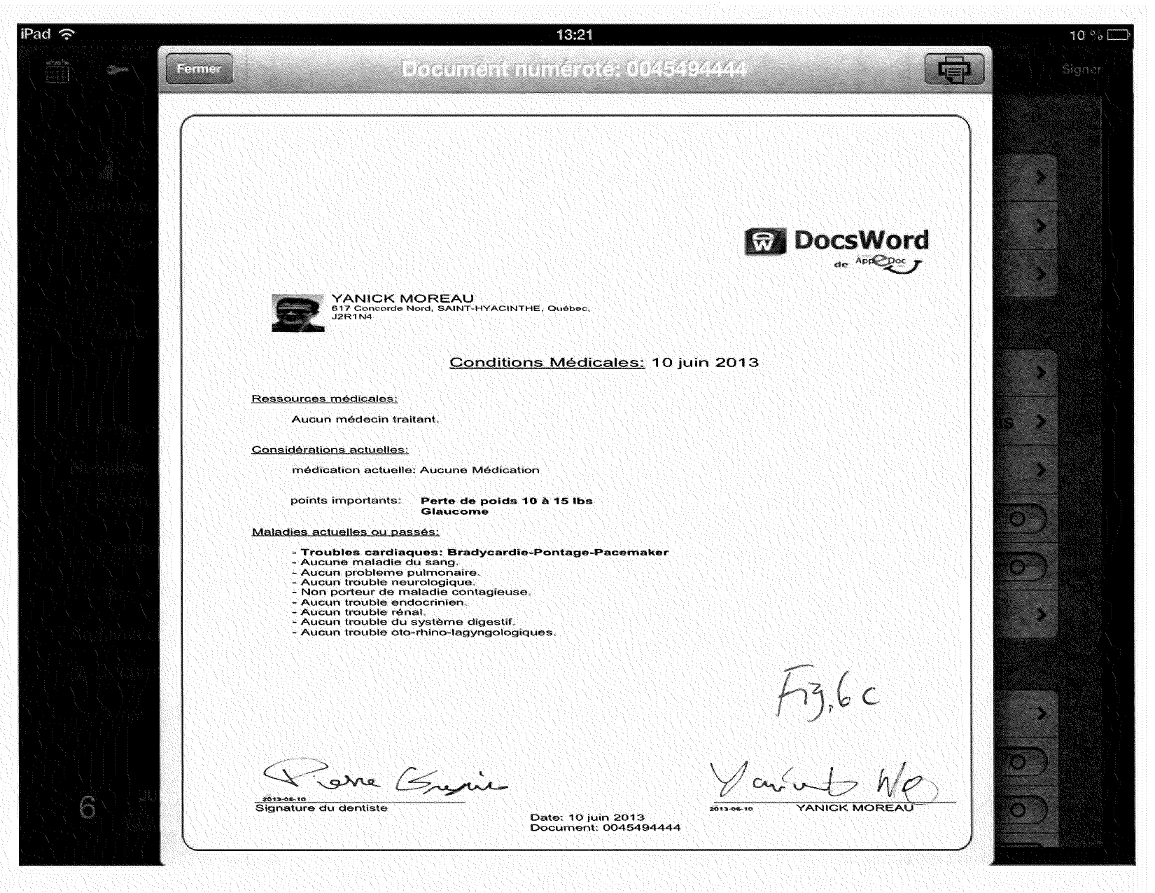

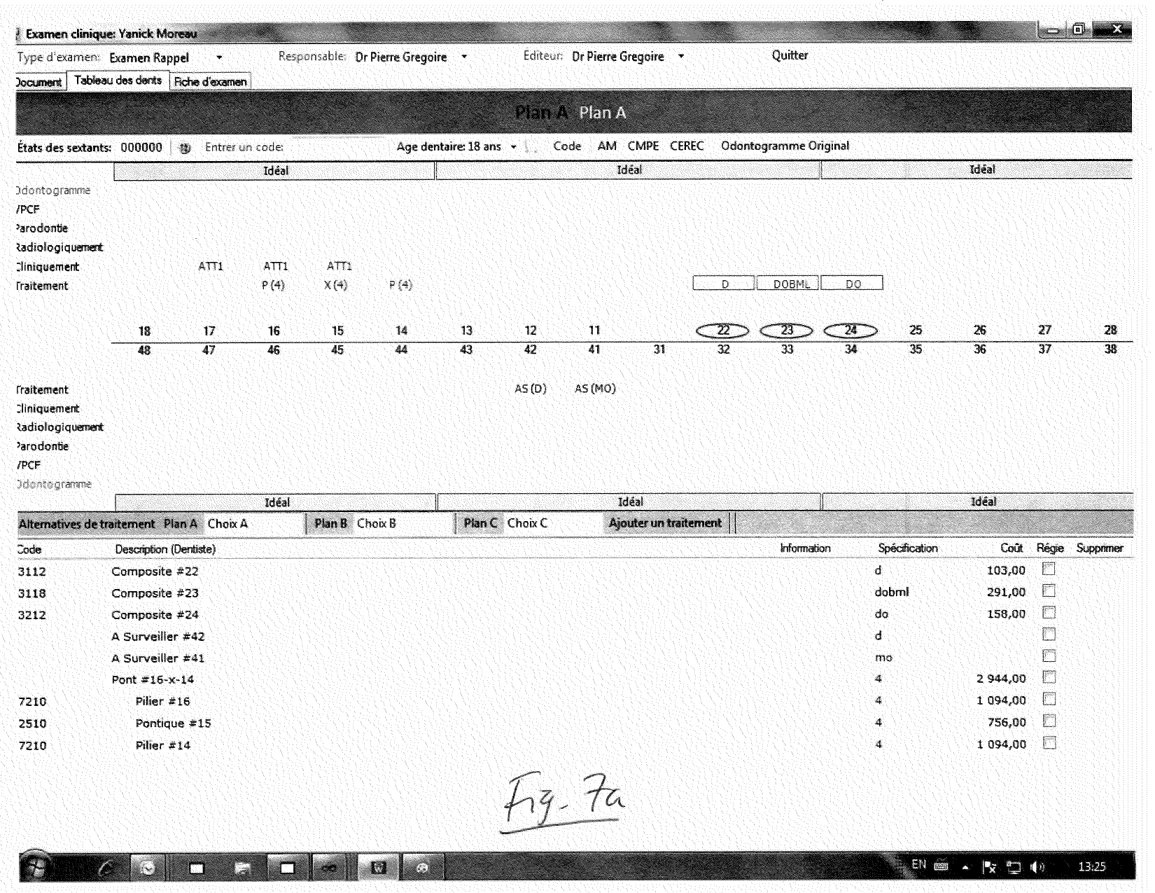

Referring to FIG. 3, therein illustrated is a schematic diagram of a method 300 for creating an uncertified electronic record according to various exemplary embodiments. For example, steps of the method 400 may be carried out at a suitable data entry module, such as data entry module 108, 128 and 144.

At step 304, creation of record entries is completed. For example, each of the record entries may be created according to the description provided for method 200. Furthermore, each of the created record entries may be temporarily stored.

At step 308, the created record entries are associated together.

At step 312, an uncertified electronic record is created from the associated created record entries. The uncertified electronic record comprising the record entries may be sent to the server 112 and stored within the records database 116. The stored uncertified electronic record does not need to be complete. For example, further edits of record entries of the uncertified electronic record may be made. This may be done when a professional verifies the record entries and realizes that edits should be made. Furthermore, more record entries may also be added to the uncertified electronic record.

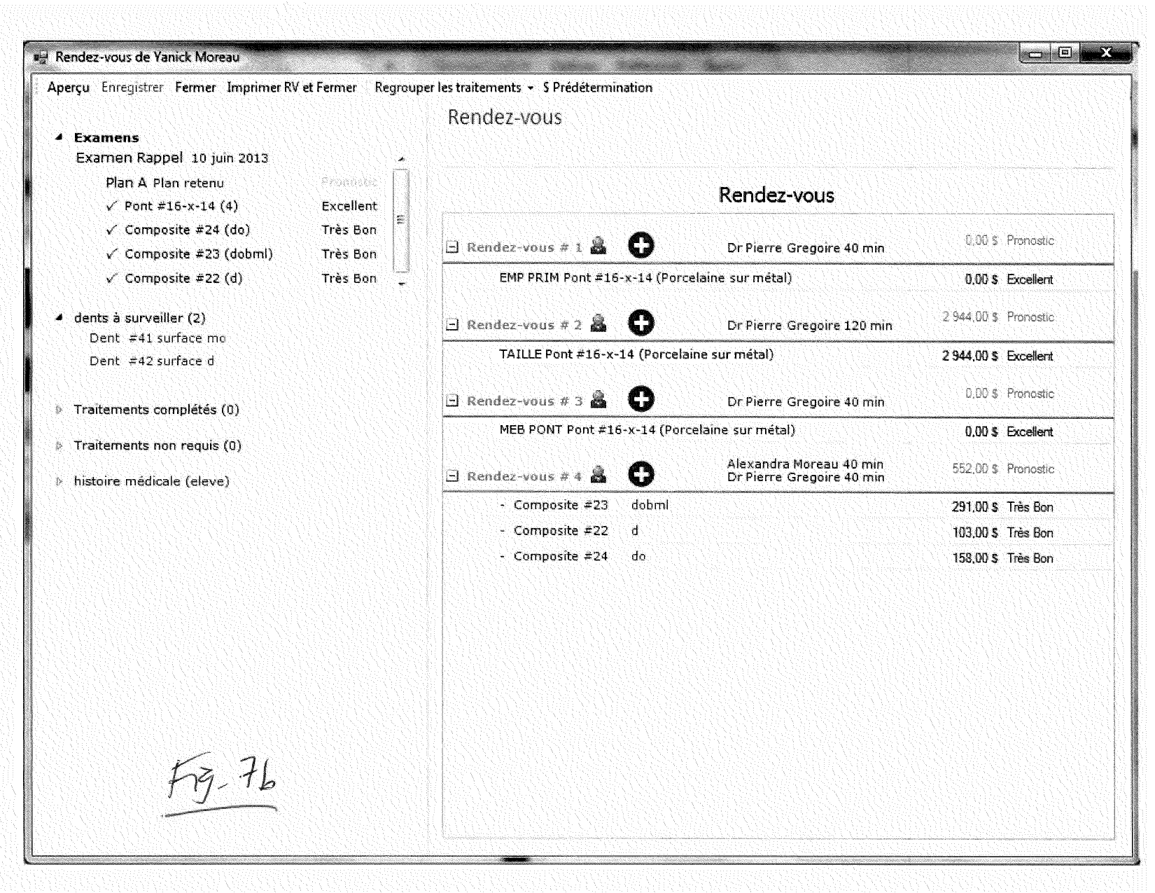

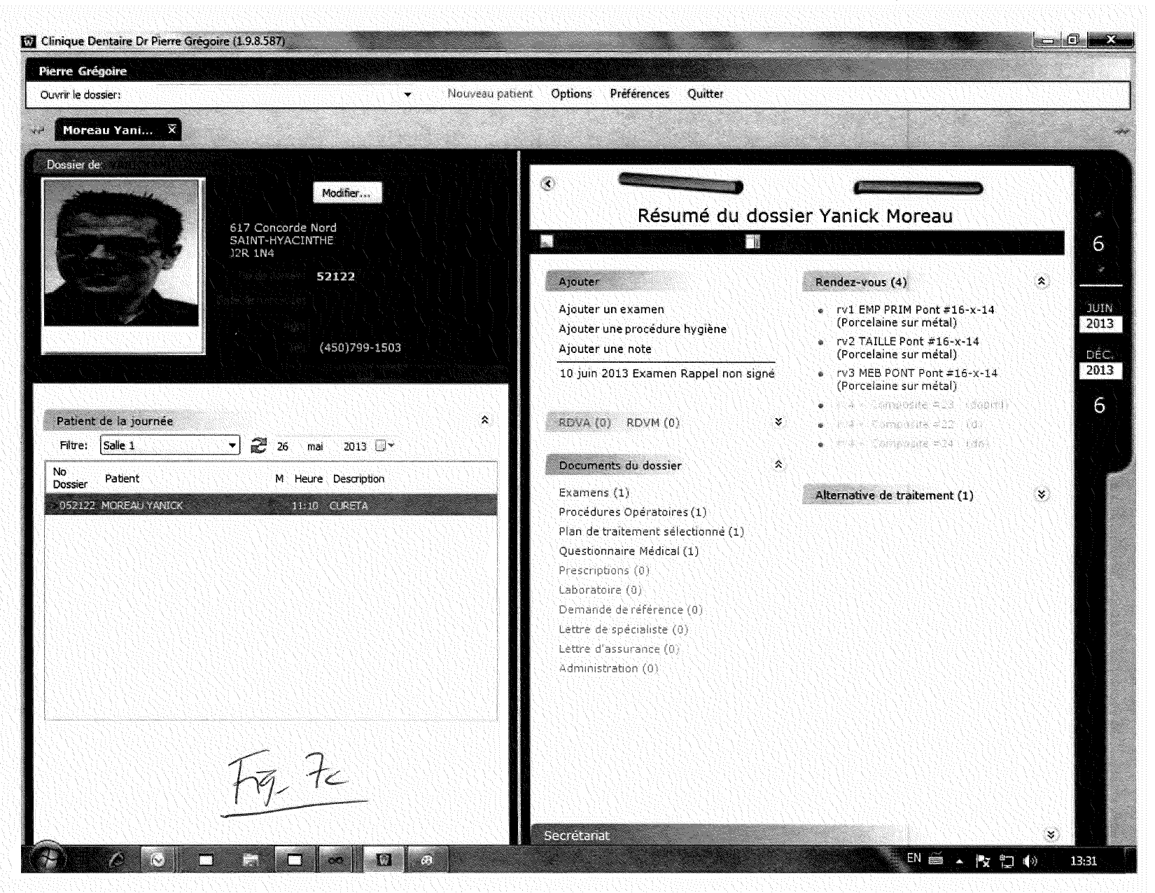

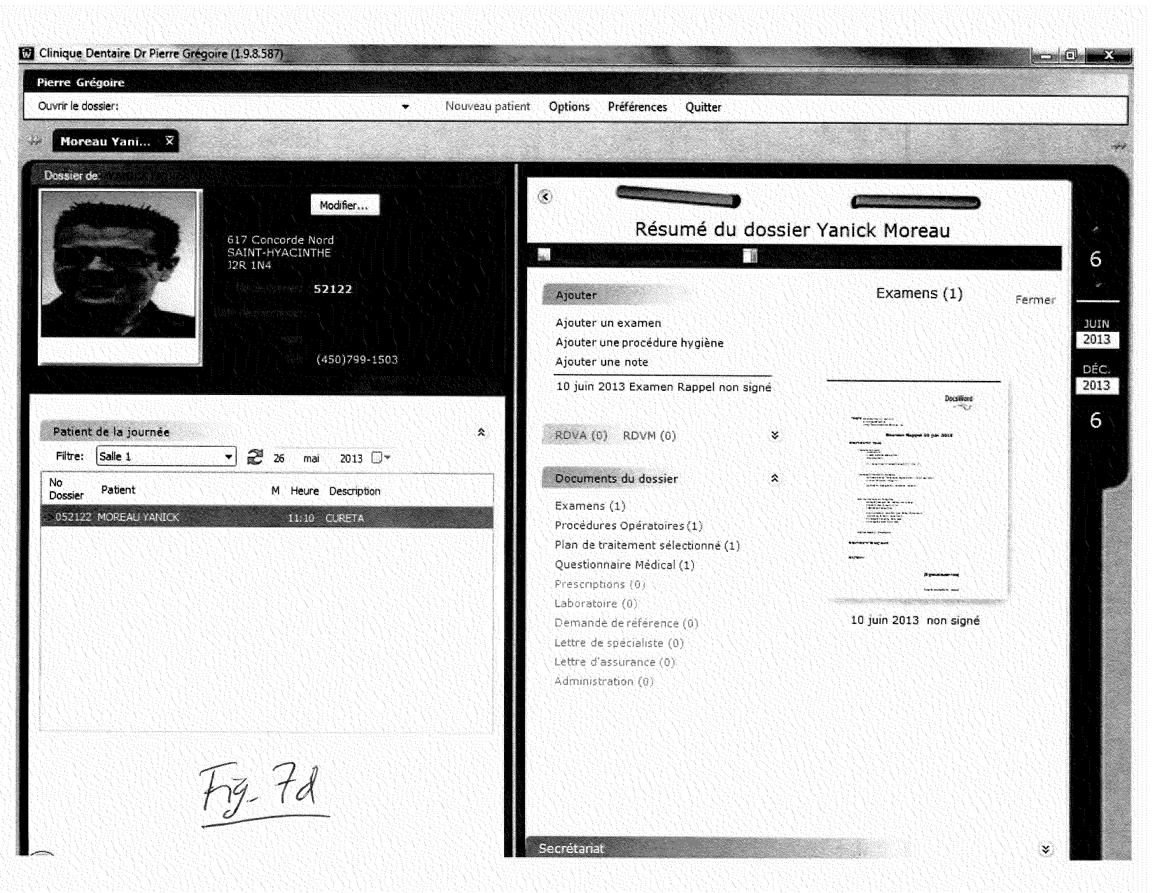

Referring to FIGS. 4 and 4a, therein illustrated is a schematic diagram, both in English and in French, of a user interface 400 for creating an electronic record in the field of dentistry. User interface 400 includes a plurality of tooth identifiers 404 that are arranged in proximity of one another. For example, the tooth identifiers 404 may be arranged in a manner that is known in the dentistry field. Each tooth identifier represents a record field for creating a record entry. Each tooth identifier may further be selectable, and more than one tooth identifier may be selected simultaneously. This results in simultaneous selection of more than one record field. For example, FIGS. 4 and 4a show teeth identifiers having the identifier ‘31’, ‘32’ and ‘33’ as being currently highlighted and selected.

User interface 400 may further comprise a text box 406 for entering a first shortcut for the record fields corresponding to the selected tooth identifiers. User interface may also have text boxes 408, 410 and 412 corresponding to record fields for a treatment plan. Entries made in these text boxes 408, 410 and 412 create record entries for treatment plans A, B, and C.

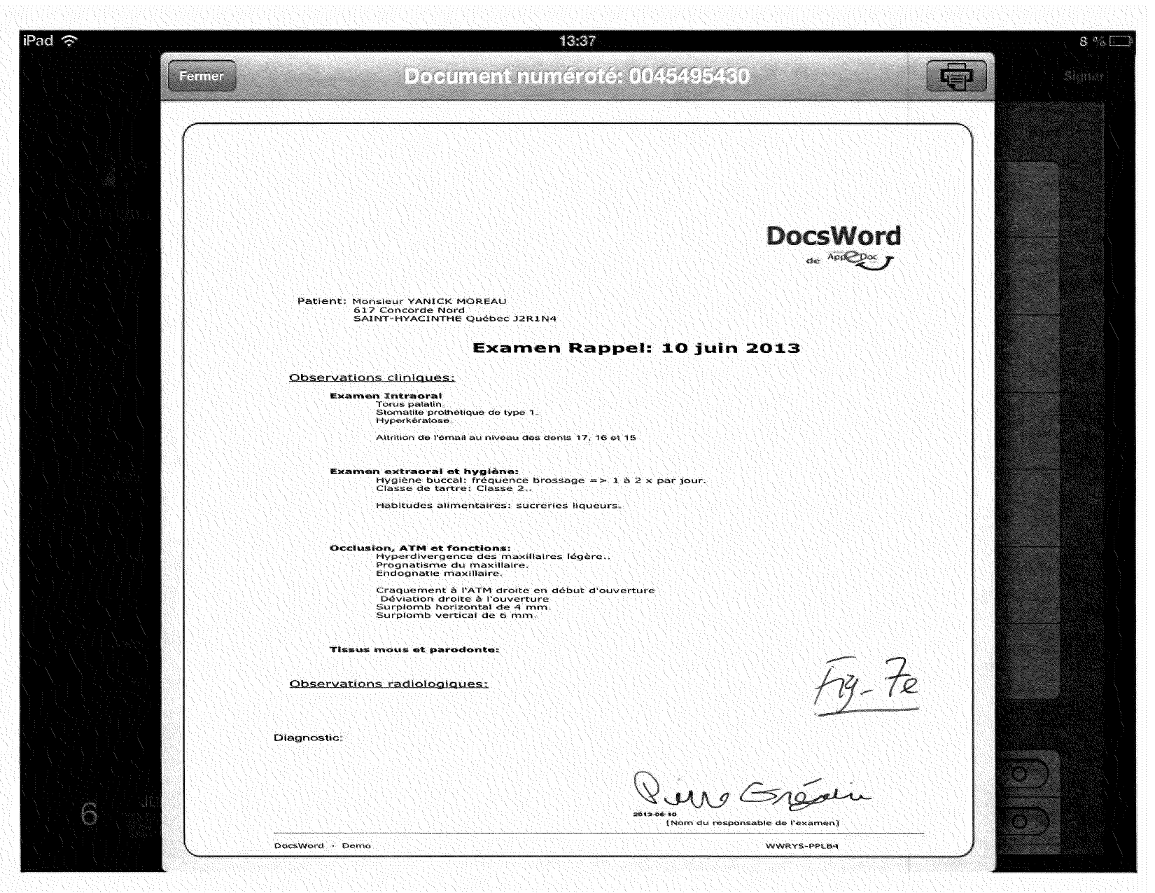

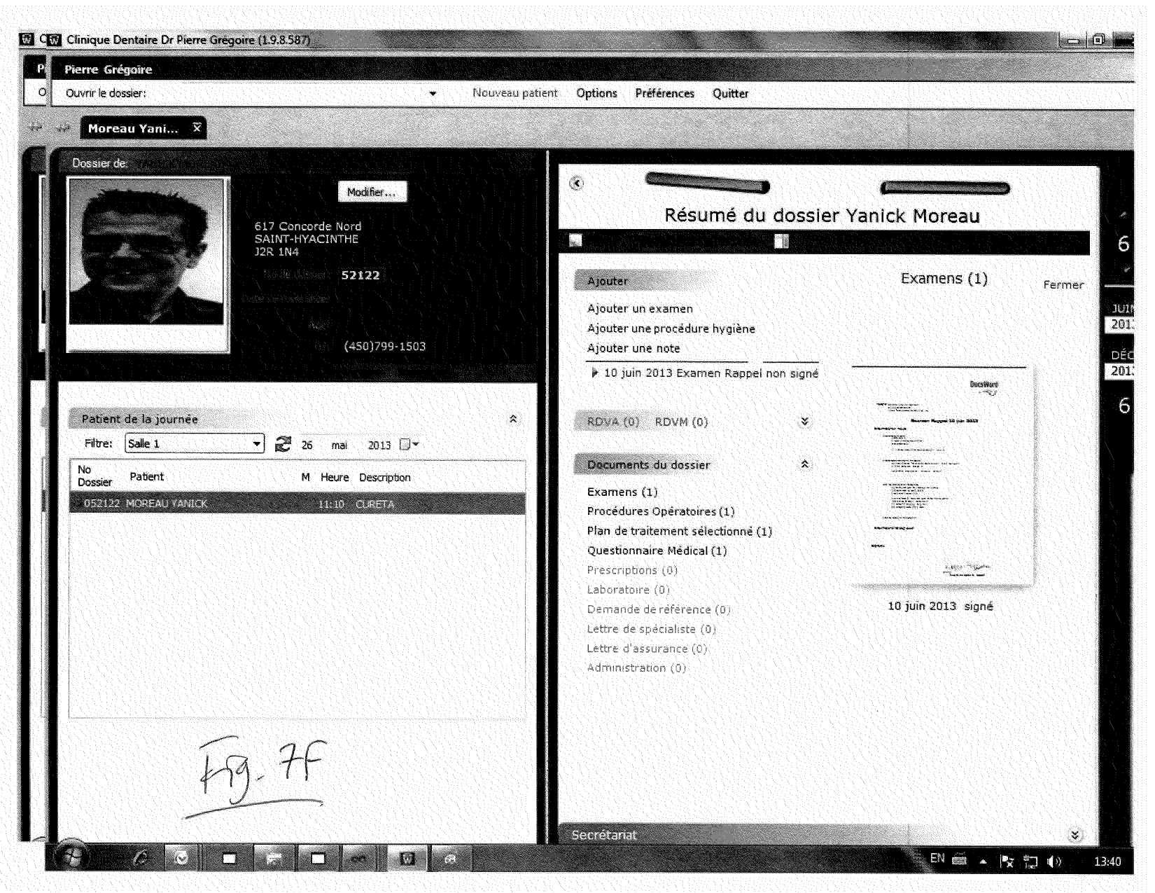

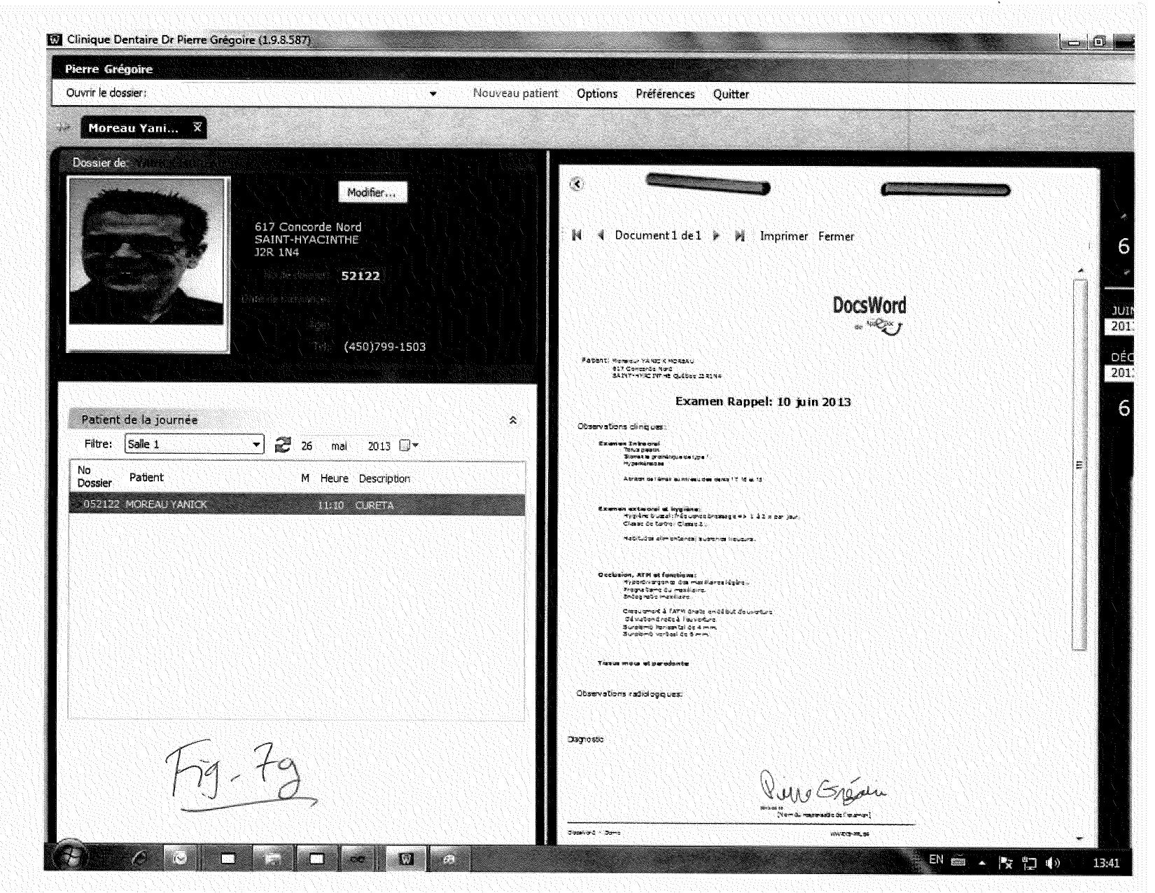

Referring now to FIG. 5, therein illustrated is a schematic diagram of the steps of a method 500 for creating a certified electronic record from an uncertified electronic record. At step 504, an already created uncertified electronic record is retrieved. The uncertified electronic record may be previously created by any workstation having a data entry module configured for creating and editing an uncertified electronic record, such as data entry module 108 of first workstation 104, data entry module 128 of second workstation 120 or data entry module 144 of portable workstation 140. The retrieved uncertified electronic record does not need to be complete, and may be completed according to the methods 300 and 400 described above after being retrieved at step 504.

The record entries of the uncertified electronic record may be displayed on a display device. A user views the record entries of the uncertified electronic record in order to verify the correctness and accuracy of the record entries. For example, where the record entries are observations taken for a completed dental procedure, a qualified dentist may view the recorded observations to determine their accuracy. When the user is satisfied of the accuracy of the record entries contained in the uncertified electronic record, they may then wish to certify the record entries to create a certified electronic record. The user certifies the electronic record by providing an input for creating a certification mark. In some fields, the action of certifying the record entries of an uncertified electronic record by providing a certification mark indicates that the user making the action is engaging their responsibility and/or liability for the accuracy of the record entries.

At step 508, a user-made input for creating a certification mark is captured by a suitable capture device. For example, the input capture module 136 of the capture device 132 may be used to capture the user-made input. The user-made input may also be made on the capture device 142 of portable workstation, with input being captured by the input capture module 148. The user-made input that is captured is a physical action or trait belonging to the user that is uniquely associated with the user. It will be appreciated that since the input is a physical action or trait, it cannot readily be shared or forged, which increases the reliability in determining who made the input.

For example, the user-made input captured may be a user-made physical gesture for producing the user's handwritten signature. Accordingly, the capture device 132 or 142 may be a stylus pen or pad or a touch-sensitive pad which can track the user-made gestures. For example, the touch-sensitive pad may be a resistive or capacitive touch-sensitive pad. For example, the touch-sensitive pad may be the touch-sensitive screen of a display device, such as a touch-sensitive display of a computer monitor, cellular phone or tablet device. Accordingly, the user may move the stylus pen or slide their finger across the touch-sensitive pad in the same motion as their handwritten signature in order to input the signature.

For example, the user-made input capture may be a physical trait that is unique to the user, such as a biometric trait. Accordingly, the suitable capture device for capturing the physical trait may be selected for capture device 132 or 142. For example, the capture device may be a fingerprint sensor for sensing the user's finger, or a camera for capturing one or more body parts of the user, such as their face, retina, iris or back of the eye.

At step 512, a certification mark is generated from the user-made input captured at step 508. For example, the certification mark may be generated by the certified record creation module 124 of second workstation 120 or certified record creation module 152 of portable workstation 140.

Alternatively, the user-made input captured by the capture device may be sent to the server 112 to generate the certification mark at the certified record creation module 118 of the server 112. Data corresponding to the captured user-made input may be first encrypted before sending to the server 112.

The generated certification mark may be visually identifiable such that it may be easily identified and traced back to the user who created the certification mark. For example, the generated certification mark may be a digital image corresponding to the captured user-made input. For example, where the user-made input is for a handwritten signature, the generated certification mark may be a digital image of that handwritten signature. Where, the user-made input is a physical trait unique to the user, the generated certification mark may be a digital image of the captured physical trait.

At step 516, a certified electronic record is created by apposing the certification mark to the one or more record entries of the retrieved uncertified electronic record. The generated certification mark may be apposed such that the certification mark is associated with each of the record entries included in the created certified electronic record. For example, the certified electronic record may be created in a read-only format wherein when record entries are being displayed, the apposed certification mark is always also displayed. For example, the certified electronic record may be in an image format that comprises both. the generated certification mark and each of the record entries of the retrieved uncertified record. It will be appreciated that displaying the certification mark with any record entries that are displayed creates a permanent association between the record entries and certification mark. Furthermore, since the certification mark is visually identifiable and uniquely associated with the user, it is easy to identify the user who verified the record entries and created the certified electronic record.

Certified electronic records may be created at a suitable certified record creation module, such as certified record creation module 124 or second workstation 120 or certified record creation module 152 of portable workstation 140.

According to some exemplary embodiments, the certified electronic record may be created at the server 112, for example using certified record creation module 118. According to such embodiments, data corresponding to the captured user-made input is sent to the server 112 before certified electronic record creation at one of the workstations. To ensure security of information, data corresponding to the capture user-made input may be encrypted when sent to the server 112.

Alternatively, the record entries of the retrieved uncertified electronic record entry may be presented in an image format and the image of the retrieved record is directly altered as the user-made input is captured by the input capture module. This may be the case where the user-made input is a handwritten signature and the portions of the signature appears on the image of the retrieved record as the input is being entered. It will be appreciated that according to such embodiments, the generation of the certification mark and apposing of the generated certification mark on the record entries is carried “on-the-fly” while the user-made input is being captured. For example, after the user has finished inputting on the capture device, the image of the record entries of the retrieved uncertified electronic record is displayed with the generated certification mark juxtaposed on the image and the user is prompted to accept the generated certification mark to certify the record entries. Once the user accepts, a certified electronic record is created from the image of the record entries and the generated certification mark.

Furthermore, a certified electronic record may be made to be unalterable. For example, as soon as the user provides their user-made input to the capture device to generate a certification mark and create a certified electronic record, the record entries included in the created certified electronic record can no longer be edited. The unalterable certified electronic record may also be encrypted. Encryption may occur immediately after the user-made input is captured and a certified electronic record is created. To further ensure security, certified electronic record may be stored, for example on the server 112, in a specialized file format that cannot be directly read by any software, but can only be exported to another readable file format.

It will be appreciated that this is advantageous in fields where record entries must be verified and certified by the user and the user bears responsibility or liability for improperly made or inaccurate record entries. This may be the case of a medical or dental professional who certifies observations or procedures carried as part of a patient's medical or dental history, and who later on may be held responsible or liable for any mistakes that appear in the history.

Alternatively, or additionally, a user may like to have any record entries to which they have apposed the certification mark to be unalterable to prevent subsequent tampering of the records. This may be the case of a professional who wants to ensure that a patient's medical or dental history is not altered by a third party that tries to introduce mistakes in the record to sabotage the professional.

It will be further appreciated that making the certified electronic record unalterable introduces a further advantage over paper-based records in that paper-based records can be physically accessed to be modified or destroyed. For example, where a paper-based record contains hand-written notes, additional notes may always be made even though the piece of paper containing the record has already been signed. This possibility is eliminated with the unalterable certified electronic record bearing the apposed certification mark. In such fields, making the certified electronic records to be unalterable also serves the purpose of protecting the public. Ensuring that certified electronic records cannot be altered prevents a medical or dental professional from being able to alter a record in order to hide or erase an error appearing in the record or to add information that was otherwise omitted from the record. It will be appreciated the certified electronic record being unalterable is also desirable in various other fields that have protection of the public as one of its goals.

According to some exemplary embodiments, the creation of a certified electronic record may also be used in conjunction with paper-based records. For example, where some record entries are still made on paper, while others are created electronically, the paper-based entries may be scanned and presented as an image for review by the user. The user then reviews the scanned entries and provides the user-made input to generate a certification mark. The generated certification mark is then apposed on the scans of the paper-based entries in order to create a certified electronic record that includes the certified scanned entries.

While the above description provides examples of the embodiments, it will be appreciated that some features and/or functions of the described embodiments are susceptible to modification without departing from the spirit and principles of operation of the described embodiments. Accordingly, what has been described above is intended to be illustrative and non-limiting and it will be understood that other variants and modifications may be made without departing from the scope of the invention as defined in the claims appended hereto.

1. A method for creating a certified electronic record, the method comprising:
receiving an uncertified electronic record, the record comprising one or more entries;
receiving at a capture device an input for creating a certification mark;
generating from the input a visually identifiable certification mark;
creating the certified electronic record, the certified electronic record comprising the one or more entries and the visually identifiable certification mark.

2. The method of claim 1, wherein the input for creating a certification mark is physically inputted by a human user and wherein the visually identifiable certification mark is uniquely associated with the user.

3. The method of claim 1, wherein the visually identifiable certification mark comprises a signature.

4. The method of claim 3, wherein the capture device is selected from: a touchscreen, a stylus pen, and a touch-sensitive pad.

5. The method of claim 1, wherein the visually identifiable certification mark comprises at least one biometric trait.

6. The method of claim 5, wherein the capture device is a camera for capturing the at least one biometric trait.

7. The method of claim 1, wherein the certified electronic record is unalterable.

8. The method of claim 1, wherein if the one or more entries of the certified electronic record is displayed, the visually identifiable certification mark is also displayed.

9. A system for creating a certified electronic record, the system comprising:
a memory for storing a plurality of instructions;
a processor coupled to the memory, the processor configured for:
receiving an uncertified electronic record, the record comprising one or more entries;
receiving an input for creating a certification mark;
generating from the input a visually identifiable certification mark;
creating the certified electronic record, the certified electronic record comprising the one or more entries and the visually identifiable certification mark.

10. The system of claim 9, further comprising a capture device, wherein the input for creating a certification mark is captured by the captured device.

11. The system of claim 9, wherein the input for creating a certification mark is physically inputted by a human user and wherein the visually identifiable certification mark is uniquely associated with the user.

12. The system of claim 9, wherein the visually identifiable certification mark comprises a signature.

13. The system of claim 10, wherein the capture device is selected from: a touchscreen, a stylus pen, and a touch-sensitive pad.

14. The system of claim 9, wherein the visually identifiable certification mark comprises at least one biometric trait.

15. The system of claim 10, wherein the capture device is a camera for capturing the at least one biometric trait.

16. The system of claim 9, wherein the certified electronic record is unalterable.

17. The system of claim 9, wherein if the one or more entries of the certified electronic record is displayed, the visually identifiable certification mark is also displayed.

18. A physical non-transient computer-readable medium upon which a plurality of instructions are stored, the instructions for performing the steps of the method as claimed in claim 1.
